(19) United States
(12) Patent Application Publication
(10) Pub. No.: US 2004/0258028 A1
(43) Pub. Date: Dec. 23, 2004

(54) Method and wireless local area network (WLAN) access point controller (APC) for translating data frames

(75) Inventors: Mahmood Hossain, Pointe Claire (CA); Samy Touati, Rosemere (CA)

Correspondence Address: ALEX NICOLAESCU, Ericsson Canada Inc., Patent Department (LMC/M/P), 8400 Decarie Blvd., Town Mount Royal, QC, H4P 2N2, CA

(73) Assignee: Telefonaktiebolaget L M Ericsson (publ)

(21) Appl. No.: 10/725,590

(22) Filed: Dec. 3, 2003

Related U.S. Application Data
(60) Provisional application No. 60/480,263, filed on Jun. 23, 2003.

(51) Int. Cl. H04B 7/216

(52) U.S. Cl. 370/335

(57) ABSTRACT

A method and Wireless Local Area Network (WLAN) Access Point Controller (APC) for translating signalling and traffic Point-to-Point Protocol PPP over Ethernet (PPPoE) data frames into PPP over Generic Routing Encapsulation (GRE) data frames, and vice-versa. When a Wireless Local Area Network (WLAN) is implemented into a CDMA2000 network, a WLAN client sends PPPoE data frames to a WLAN Access Point Controller (APC) that connects to a CDMA2000 Packet Data Service Node (PDSN). The WLAN APC receives the downlink PPPoE data frames and converts them in PPP over GRE data format understood by the CDMA2000 PDSN, and relays the translated frames to the PDSN. In the uplink, the WLAN APC receives PPP over GRE data frames from the PDSN, frames that are intended for the WLAN client, and translates them into PPPoE data frames, which are relayed to the WLAN client.

### PRIORITY STATEMENT UNDER 35 U.S.C. S.119(e) & 37 C.F.R. S.1.78

This non-provisional patent application claims priority based upon the prior U.S. provisional patent application entitled “PPPoE Relay Engine”, application No. 60/480,263, filed Jun. 23, 2003, in the names of HOSSAIN Mahmood and TOUATI Samy.

### BACKGROUND OF THE INVENTION

1. Field of the Invention

The present invention relates to a method and system for translating data communications from a Wireless Local Area Network (WLAN) using Point-to-Point Protocol over Ethernet (PPPoE) to a Point-to-Point Protocol (PPP) format used by a CDMA2000 based network.

2. Description of the Related Art

A Wireless Local Area Network (WLAN) is a Local Area Network (LAN) to which a mobile user can connect through a wireless (radio) connection. The Institute of Electrical and Electronics Engineers (IEEE) has defined several sets of standard specifications, such as for example 802.11, 802.16, and 802.20, that specify the technologies to be used for WLANs. For example, in the set of standard specifications 802.11, there are currently four specifications: 802.11, 802.11a, 802.11b, and 802.11g, all of which are herein included by reference. All four use the Ethernet protocol and CSMA/CA (Carrier Sense Multiple Access with Collision Avoidance) for path sharing.

The most recently approved standard, 802.11g, offers wireless transmission over relatively short distances at up to 54 megabits per second (Mbps) compared with the 11 megabits per second of the 802.11b standard. Like 802.11b, 802.11g operates in the 2.4 GHz range and is thus compatible with it.

The 802.11b standard—often called Wi-Fi (Wireless Fidelity) uses a modulation called Complementary Code Keying (CCK), which allows higher data speeds and which is less susceptible to multipath-propagation interference, while the modulation used in 802.11 has historically been phase-shift keying (PSK).

The 802.11a specification applies to wireless ATM systems and is used in access hubs. 802.11a operates at radio frequencies between 5 GHz and 6 GHz. It uses a modulation scheme known as Orthogonal Frequency-Division Multiplexing (OFDM) that makes possible data speeds as high as 54 Mbps, but most commonly, communications takes place at 6 Mbps, 12 Mbps, or 24 Mbps.

Wi-Fi (short for “wireless fidelity”) is the popular term for a high-frequency WLAN. The Wi-Fi technology is rapidly gaining acceptance in many companies as an alternative to a wired LAN. Wi-Fi can also be installed in a home network.

The use of WLANs with high-bandwidth allocation for wireless service makes 2 0 possible a relatively low-cost radio connection for WLAN users which terminals are equipped with WLAN adapters. Such adapters can be made to fit on a Personal Computer Memory Card Industry Association (PCMCIA) card for laptop or notebook computers. In actual fact, more and more computer equipment providers, such as for example IBM, Toshiba, and Dell commercialize personal computers with embedded WLAN adaptors, while more and more Personal Digital Assistants (PDAs) comprise WLAN cards as well.

On the other hand, today's mobile network operators are facing a strong challenge in deploying Third Generation (3G) cellular networks due to huge infrastructure and spectrum licensing costs as well as maturity of the technology itself. Infrastructure for 3G networks is expensive and represents an actual burden for the cellular network operators. This problem is further exacerbated by radio coverage requirements imposed by governmental agencies on network operators, who are often requested to insure total radio coverage even in areas where the expected traffic does not justify such coverage.

WLAN has gained enormous ground not only in market acceptance for deployment of WLAN Access Points (AP) for SOHO (Small Office Home Office) use, but also into the every day consumer communication products. WLAN has now become an accepted technology. However, with the current cost burden of building and deploying a 3G network, 3G operators may not have the same luxury of deploying multiple 3G base stations to solve network congestion where both voice and data will compete for the same traffic channels.

A solution to ease the burden of congestion in 3G radio cells is to allow WLAN to be overlapped in high-density areas such as metropolitan areas where cell congestion becomes increasingly common. Integrating WLAN to cover areas where radio coverage is heavily competed for both voice and data can allow network operators to deploy sufficient radio coverage quickly and easily using WLAN in order to offload data traffic from the cellular network when congestion occurs, and continue with voice over the cellular network.

A problem arises, however, because the data transmission protocol used in WLANs is different from the one used in certain cellular systems. In a typical WLAN, Ethernet broadcast media is used as data link layer protocol whereas in 3G cellular networks PPP (Point-to-Point Protocol) is used as the communications protocol between the mobile node and the network point of attachment.

PPP is a well-known protocol for communication between two computer systems using a serial interface, typically a personal computer connected via certain communications means to a server. For example, an Internet server provider may provide a client with a PPP connection so that the provider's server can respond to the client's requests, transmit them to the Internet, and forward back the requested Internet responses. PPP uses the Internet protocol (IP) (and is designed to handle others). It is sometimes considered a member of the TCP/IP suite of protocols. Relative to the Open Systems Interconnection (OSI) reference model, PPP provides layer 2 (data-link layer) service. Essentially, it packages the computer's TCP/IP packets and forwards them to the server where they can actually be put on the Internet.

PPP is a full-duplex protocol that can be used on various physical media, including twisted pair or fiber optic lines or satellite transmission. It uses a variation of High Speed Data Link Control (HDLC) for packet encapsulation. PPP can handle synchronous as well as asynchronous communication and can share a line with other users and it has error detection.

PPPoE (Point-to-Point Protocol over Ethernet) is a specification for connecting multiple computer users on an Ethernet Local Area Network (LAN) to a remote site through common customer premises equipment, which is the telephone company's term for a modem and similar devices. PPPoE can be used to have an office or building-full of users share a common Digital Subscriber Line (DSL), cable modem, or wireless connection to the Internet. PPPoE combines the PPP, commonly used in dialup connections, with the Ethernet protocol, which supports multiple users in a local area network. In PPPoE, the PPP protocol information is encapsulated within an Ethernet frame.

PPPoE has the advantage that neither the telephone company nor the Internet Service Provider (ISP) needs to provide any special support. Unlike dialup connections, DSL and cable modem connections are “always on.” Since a number of different users are sharing the same physical connection to the remote service provider, a way is needed to keep track of which user traffic should go to and which user should be billed. PPPoE provides for each user-remote site session to learn each other's network addresses (during an initial exchange called “discovery”). Once a session is established between an individual user and the remote site (for example, an ISP), the session can be monitored for billing purposes.

PPPoE is also the communication standard used by WLANs. In such a configuration, a Mobile Node (MN) equipped with a WLAN client establishes a WLAN connection with a WLAN Access Point Controller (WLAN-APC) using a PPPoE connection. However, when the WLAN is integrated with a CDMA2000 cellular network, the WLAN-APC must further relay the data session to a CDMA 2000 Packet Data Service Node (PDSN), which provides access to the Internet, intranets and applications servers for mobile nodes. However, while a CDMA2000 PDSN supports PPP data sessions encapsulated in GRE (Generic Routing Encapsulation) frames, it cannot understand PPPoE data sessions that a WLAN client originates.

Due to this incompatibility, it is impossible for current WLAN clients to establish a full PPP connection up to a CDMA 2000 PDSN, and to seamlessly integrate a CDMA2000 cellular network.

Accordingly, it should be readily appreciated that in order to overcome the deficiencies and shortcomings of the existing solutions, it would be advantageous to have a method and system for effectively relaying data traffic originated by mobile nodes equipped with a WLAN client to the CDMA 2000 cellular network. The present invention provides such a method and system.

### SUMMARY OF THE INVENTION

In one aspect, the present invention is a method for translating a data frame, the method comprising the steps of:

a. receiving a Point-to-Point Protocol (PPP) over Ethernet (PPPoE) data frame; and

b. translating the PPPoE data frame into a PPP over Generic Routing Encapsulation (GRE) data frame.

In another aspect, the invention is a Wireless Local Area Network (WLAN) Access Point Controller (APC) that acts to receive a Point-to-Point Protocol (PPP) over Ethernet (PPPoE) data frame and to translate the PPPoE data frame into a PPP over Generic Routing Encapsulation (GRE) data frame.

In yet another aspect, the invention is a method for translating a data frame, the method comprising the steps of:

a. receiving a PPP over Generic Routing Encapsulation (GRE) data frame; and

b. translating the PPP over GRE data frame into a Point-to-Point Protocol (PPP) over Ethernet (PPPoE) data frame.

In another aspect, the invention is a Wireless Local Area Network (WLAN) Access Point Controller (APC) that acts to receive a PPP over Generic Routing Encapsulation (GRE) data frame and to translate the PPP over GRE data frame into a Point-to-Point Protocol (PPP) over Ethernet (PPPoE) data frame.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level network diagram illustrative of a data communications network where the preferred embodiment of the invention can be advantageously implemented;

FIG. 2 is an exemplary high-level representation of a translation of a Point-to-Point Protocol (PPP) over Ethernet (PPPoE) data traffic payload into PPP over Generic Routing Encapsulation GRE, and vice-versa, according to the preferred embodiment of the present invention; and

FIG. 3 is an exemplary nodal operation and signal flow diagram of a data communications network implementing the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and system for relaying Point-to-Point Protocol (PPP) data packets from a Point-to-Point Protocol (PPP) over Ethernet (PPPoE) based Wireless Local Area Network (WLAN) to a CDMA2000 based cellular telecommunications network without the needs to decapsulate PPP frames. As it is well known in the art, in CDMA2000 cellular telecommunications networks, the PPP session extends from the Mobile Node (MNs) up to the Packet Data Switching Node (PDSNs). However, when an MN is served in a WLAN network, the ongoing PPP session is encapsulated into PPP over Ethernet (PPPoE) frames between the MN and a WLAN Access Point Controller (APC). According to the present invention, the WLAN APC comprises a translation engine that is able to decapsulate uplink PPP frames including the IP payload from the PPPoE format and to encapsulate the remaining PPP frames into a format appropriate for the transmission to the PDSN, i.e. into a Generic Routing Encapsulation (GRE) format. Likewise, in the opposite direction, when download traffic is directed from the PDSN to the MN served by the WLAN network, the download PPP frames that reaches the WLAN APC encapsulated in the GRE format are decapsulated from that format, and encapsulated into a PPPoE formats specific to the WLAN.

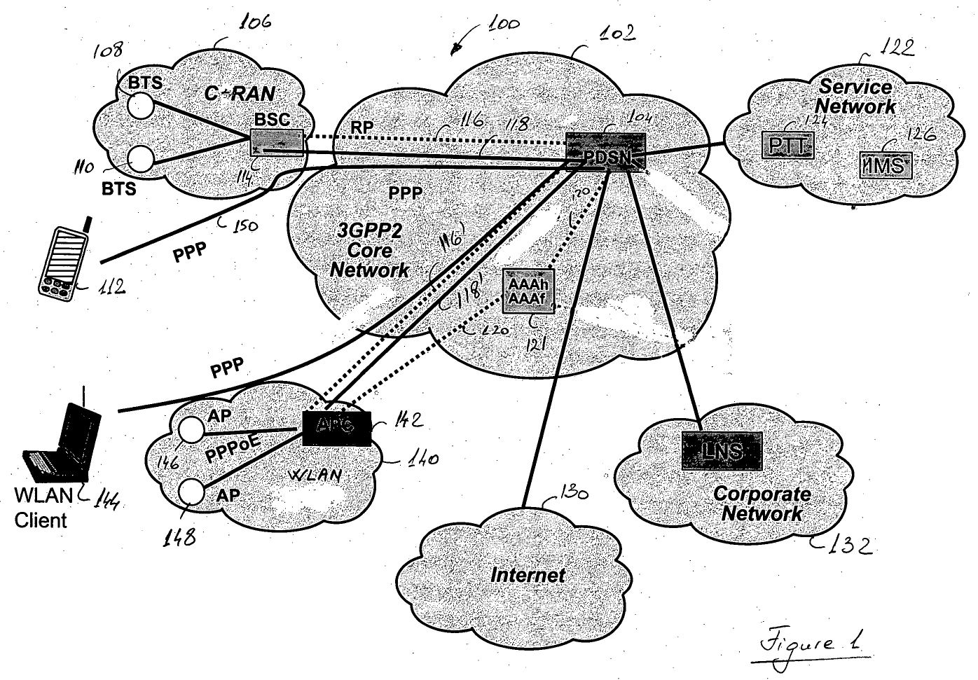

Reference is now made to FIG. 1, which is an exemplary high-level network diagram illustrative of a data communications network 100 where the preferred embodiment of the invention can be advantageously implemented. The data communications network 100 may comprise a CDMA2000-based core network 102 that may function according to the Third Generation Partnership Project (3GPP2) specifications TIA/EIA IS835 Rev. A, which is herein included by reference. The core network 102 may comprise at least one PDSN 104, which is the node responsible for the switching and routing of the data packets originated and intended for MNs serviced by the network 100. Also illustrated in FIG. 1, is a CDMA2000 radio access network 106 comprising a plurality of Base Transceiver Stations (BTS) 108 and 110 responsible for providing cellular radio service to mobile nodes such as for example to the MN 112. A Base Station Controller (BSC) 114 controls the BTSs 108 and 110 and is linked via a signaling path 116 and a data traffic path 118 to the PDSN 104. Within the core network 102, the PDSN 104 may also connect via signaling link 120 to an Authentication, Authorization, and Accounting (AAA) server 121 responsible for authorizing, authenticating and for providing accounting services for the mobile nodes of network 100. The PDSN 104 further connects to a service network 122 that is responsible for implementing various subscriber services such as for example Push-To-Talk services (PTT) 124 and Multimedia Messaging Services (MMS) 126. The PDSN 104 may also connect to the Internet 130 and to a corporate network 132, which subscribers of the mobile nodes can access via the core network 102.

Also illustrated in FIG. 1 is a WLAN network 140 that includes an APC 142, which is responsible for the switching and routing of data packets originated from the WLAN 140 and destined to WLAN clients, such as for example the WLAN client 144. The connection between the APC 142 and the WLAN 144 takes place through anyone of the access points 146 and 148 responsible for providing WLAN radio service to WLAN clients. Just as the BSC 114, the Wireless LAN APC 142 also connects to the PDSN 104 via a data traffic communication link 118′ and a signaling link 116′, and further connects to the MA server 121 via signaling link 120.

When the MN 112 is served via the CDMA2000 radio access network 106 by the PDSN 104, a PPP session 150 is established from the MN to the PDSN 104 via the serving BTS 110 and BSC 114. In order to extend the point-to-point link up to PDSN, the BSC 114 establishes a special Radio-Packet (R-P) Tunnel between the BSC 114 and the PDSN 104 to carry the PPP session towards the PDSN 104. The signaling required for establishing the special R-P tunnel is takes place along the signaling link 116, as it is well known in the art as defined in the specification for the TIA/EIA/IS2001 A11 interface. Following the R-P session establishment, data traffic is exchanged over the logical PPP session using the data traffic connection 118.

When the MN roams into a WLAN hotspots, the WLAN client 144 establishes a PPPoE session with the WLAN APC 142. However, the PDSN 104 where the PPP session with the wireless LAN clients must terminate is not capable of supporting PPPoE data communications, since in CDMA2000-based network, the PDSNs are not capable of understanding the Ethernet-based PPP frames (PPPoE), and can rather only support PPP sessions frame format encapsulated in the Generic Routing Encapsulation (GRE) format. Therefore, according to the present invention, the WLAN APC 142 converts PPPoE format into PPP format accepted by the PDSN 104, and vice versa, the format understood by the PDSN 104 into PPPoE format. The frame format associated with PPP sessions supported by the PDSN 104 is the GRE format.

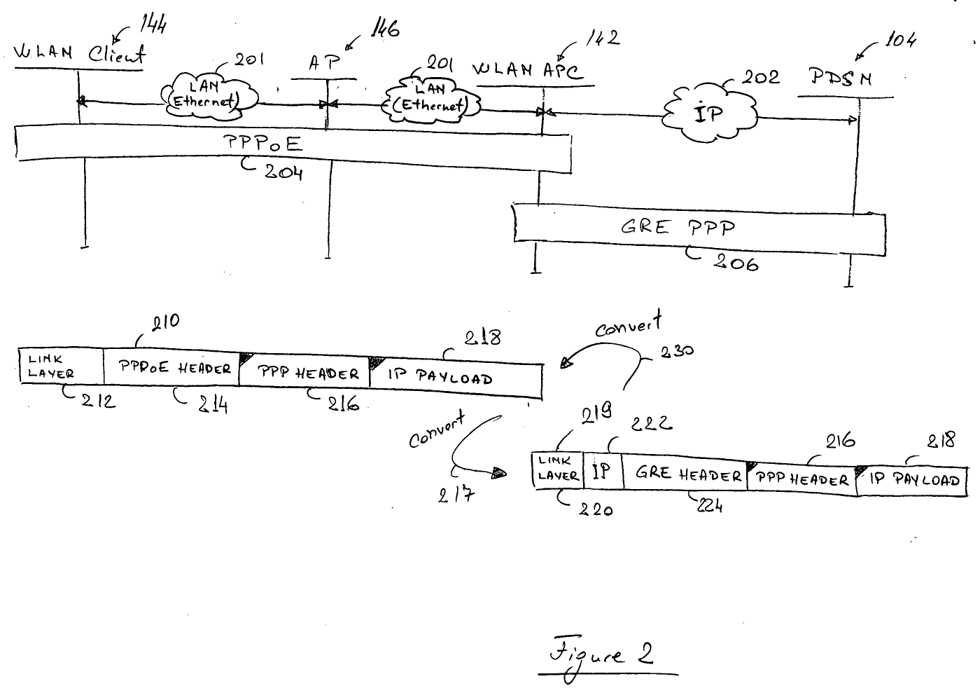

Reference is now made to FIG. 2, which is an exemplary high-level representation of a translation performed by the WLAN APC 142 between the PPPoE format and the IP format understood by the PDSN 104 according to the preferred embodiment of the present invention. Shown in FIG. 2, is the wireless client 144, the Access Point (AP) 146, and the WLAN APC 142, which are connected through an Ethernet-based Local Area Network (LAN) 201. The APC 142 also connects to the PDSN 104 via an IP link 202. A PPPoE data session 204 extends from the WLAN client 144 up to the WLAN APC 142 via the access point 146. Between the Wireless LAN APC 142 and the PDSN 104 extends a PPP session 206 over IP using GRE framing.

Therefore, according to the present invention, the WLAN APC 142 translates the PPPoE format into the PPP over IP format, and vice versa, in order to provide seamless connectivity between the WLAN client 144 and the PDSN 104.

In particular, a data frame 210 exchanged between the WLAN client 144 and the WLAN APC 142 comprises a link layer portion 212 for Ethernet framing required in LAN segments. The frame 210 further comprises a PPPoE header 214 that comprises information related to PPP session management signaling information required in LAN environment. Finally, the frame 210 comprises a PPP header 216 that contains information related to logical point-to-point link between the mobile node 144 and the APC 142, as well as an IP payload 218 that comprises the actual packets to and from the client 144. When the WLAN APC 142 receives such a frame from the WLAN client 144, it must convert the frame 210, action 217, into a format appropriate for the transmission to the PDSN 104. A frame 219 according to this format comprises a different link layer 220 as required by the physical media between the APC 142 and the PDSN 104, an IP section 222 to carry GRE frames over the IP network between the APC and the PDSN and a GRE header 224 to encapsulate or relay the original PPP frames between the client 144 and the PDSN 104. Finally, the frame 2119 comprises the PPP header 216 and the IP payload 218.

In an analogous manner, when downlink traffic occurs from the PDSN 104 to the WLAN client 144, the WLAN APC 142 proceeds to an analogous conversion 230 from the format of frame 219 to the format of frame 210.

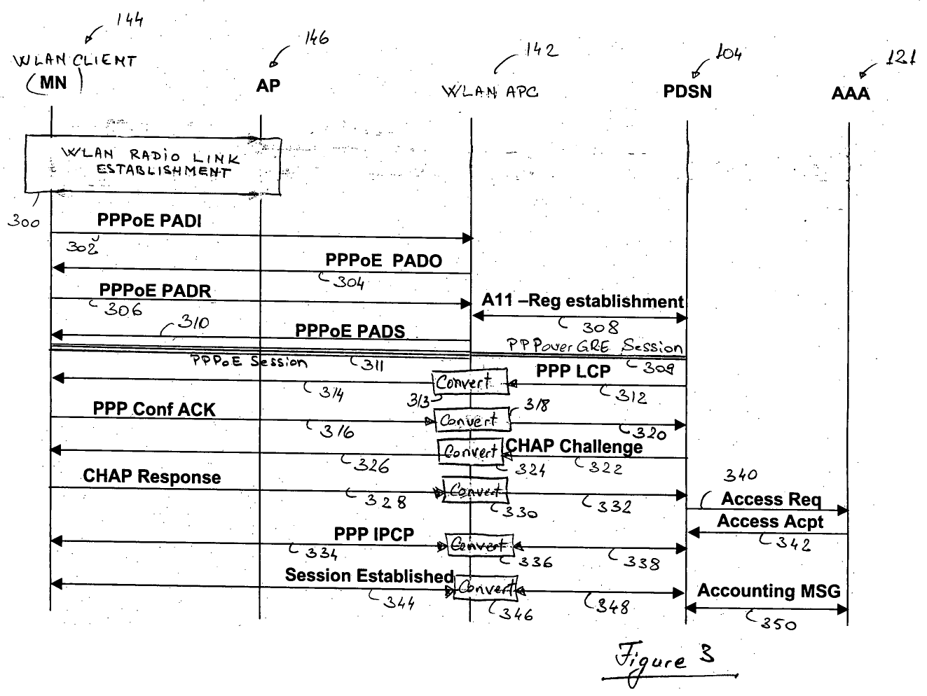

Reference is now made to FIG. 3, which is an exemplary nodal operation and signal flow diagram of a data communications network 100 according to the preferred embodiment of the present invention. Shown in FIG. 3 is the wireless client 144 that can be part of a mobile node (MN), the access point 146, the WLAN APC 142, the PDSN 104 and the MA server 121. First, in action 300, when the WLAN client 144 enters a WLAN hotspot served by the access point 146, the WLAN client 144 establishes a new radio link with the WLAN access point 146. Once the radio links is established, in action 302, the WLAN client 144 broadcasts a PPPoE Active Discovery Initiation (PPPoE PADI) message in order to inquire if there is any WLAN access concentrator available, such as for example the WLAN APC 142. The latter receives the message 302, and responsive to that message, it responds in action 304 with a PPPoE Active Discovery Offer (PPPoE PADO), in which it offers to the WLAN client 144 to act as an access concentrator for providing a WLAN session. In action 306, the WLAN client 144 responds back to the WLAN APC 142 with a PPPoE Active Discovery Request (PPPoE PADR) message, which represents the WLAN client 144 acceptance of the WLAN APC 142 to act as an access concentrator for the new WLAN data session. Responsive to the message 306, the WLAN APC 142 establishes a new GRE session 309 with the PDSN 104 using regular A11 R-P session establishment signalling, action 308. Once the GRE session 309 is established between the WLAN APC 142 and PDSN 104, the WLAN APC 142 responds back to the WLAN client 144 with a PPPoE Active Discovery Session confirmation (PPPoE PADS), which indicates to the WLAN client 144 a PPP session number that identifies the PPP session established with the PDSN 104, action 310. The PPP session number along with a source and destination Ethernet addresses of the client 144 and the APC 142 uniquely identifies the PPPoE data session 311 that is established between the wireless line client 144 and the WLAN APC 142.

The PPPoE link is already established between the WLAN client 114 and the APC 142. From now on, it is the regular PPP negotiation that takes place between the WLAN client and the APC 142, which is relayed by the APC to the PDSN 104.

In action 312, a Link Control Protocol (LCP) message is sent by the PDSN 104 to the APC 142. The latter receives the message 312 in the GRE format, previously described, and translates the message into the PPPoE format. Finally, the translated message 314 is relayed by the APC 142 to the WLAN client 144. In action 316, an acknowledgment of the LCP message 314 is received by the APC 146, and is translated in the opposite direction, i.e. from the PPPoE format into the GRE format, action 318, and is relayed to the PDSN 104, action 320. Messages 316 and 320 contain the authentication that is supported by the WLAN client (144). In action 322, the PDSN 104 issues a CHAP challenge message that is translated, action 324, and relayed in action 326 to the WLAN client 144.

In action 328 the WLAN client 144 issues a CHAP response message, in which it uses the challenge to encrypt a password with a timestamp and the challenge. In action 330, this message is translated into the GRE format and sent, action 332, to the PDSN 104. The latter issues in action 340 an Access request message containing the credential of the user. Message 340 may be a User Datagram Protocol (UDP) Remote Authentication Dial-In User Service (RADIUS) message going to the AAA server 121. The AAA server 121 answers with an Access Accept message 342, which indicates that the user has been authenticated.

In action 338, the PDSN 104 issues a PPP Internet Protocol Control Protocol (IPCP) message intended for the WLAN client 144, for negotiating the IP layer of the connection, including the IP Addresses, a Domain Name Server (DNS) IP addresses, and the IP gateway. The APC 142 receives the message 338 and translates it from the PPP over GRE format into the PPPoE format, action 336, and relays the translated message 334 to the WLAN client 144. At this point in time the session is ready to be established, and in action 344, the data traffic of the WLAN client is relayed to the APC 142, translated in action 346 from the PPPoE format into the PPP over GRE format, action 346, and relayed to the PDSN 104, action 348. Traffic from and to the WLAN client 144 triggers the generation of RADIUS accounting messages in action 350.

Based upon the foregoing, it should now be apparent to those of ordinary skills in the art that the present invention provides an advantageous solution, which offers an advantageous method and system allowing the deployment of WLAN hot-spots into CDMA2000 cellular networks, wherein an APC connected to the CDMA2000 PDSN seamlessly translates uplink PPPoE frames from the WLAN client into PPP over GRE frames intended for the PDSN. In the reverse direction, i.e. in the downlink, the APC acts to translate PPP over GRE frames into PPPoE frames intended for the WLAN client. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth herein below.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for translating a data frame, the method comprising the steps of:
a. receiving a Point-to-Point Protocol (PPP) over Ethernet (PPPoE) data frame; and
b. translating the PPPoE data frame into a PPP over Generic Routing Encapsulation (GRE) data frame.

2. The method claimed in claim 1 further comprising the step of:
c. sending the PPP over GRE data frame to a Packet Data Service Node (PDSN) of a CDMA2000 network.

3. The method claimed in claim 1 further comprising the step of:
d. prior to step a., sending the PPPoE data frame from a Wireless Local Area Network (WLAN) client to a WLAN Access Control Point (APC);
wherein step a. is performed in the WLAN APC.

4. The method claimed in claim 1, wherein step b. comprises the step of:
b.1 converting an Ethernet header of the PPPoE data frame to a GRE header in the PPP over GRE data frame.

5. The method claimed in claim 1, wherein the PPPoE data frame is a signaling data frame.

6. The method claimed in claim 1, wherein the PPPoE data frame is a traffic data frame.

7. A Wireless Local Area Network (WLAN) Access Point Controller (APC) that acts to receive a Point-to-Point Protocol (PPP) over Ethernet (PPPoE) data frame and to translate the PPPoE data frame into a PPP over Generic Routing Encapsulation (GRE) data frame.

8. The WLAN APC claimed in claim 7 wherein the WLAN APC sends the PPP over GRE data frame to a Packet Data Service Node (PDSN) of a CDMA2000 network.

9. The WLAN APC claimed in claim 7 wherein the WLAN APC receives the PPPoE data frame from a Wireless Local Area Network (WLAN) client.

10. The WLAN APC claimed in claim 7, wherein the WLAN APC converts an Ethernet header of the PPPoE data frame into a GRE header in the PPP over GRE data frame.

11. The WLAN APC claimed in claim 7, wherein the PPPoE data frame is a signaling data frame.

12. The WLAN APC claimed in claim 7, wherein the PPPoE data frame is a traffic data frame

13. A method for translating a data frame, the method comprising the steps of:
a. receiving a PPP over Generic Routing Encapsulation (GRE) data frame; and
b. translating the PPP over GRE data frame into a Point-to-Point Protocol (PPP) over Ethernet (PPPoE) data frame.

14. The method claimed in claim 13 further comprising the step of:
c. sending the PPPoE data frame to a WLAN client of a WLAN network.

15. The method claimed in claim 13 further comprising the step of:
d. prior to step a., sending the PPP over GRE data frame from a Packet Data Service Node (PDSN) of a CDMA2000 network to a WLAN Access Control Point (APC);
wherein step a. is performed in the WLAN APC.

16. The method claimed in claim 13, wherein step b. comprises the step of:
b.1 converting a GRE header of the PPP over GRE data frame into an Ethernet header of the PPPoE data frame.

17. The method claimed in claim 13, wherein the PPPoE data frame is a signaling data frame.

18. The method claimed in claim 13, wherein the PPPoE data frame is a traffic data frame.

19. A Wireless Local Area Network (WLAN) Access Point Controller (APC) that acts to receive a PPP over Generic Routing Encapsulation (GRE) data frame and to translate the PPP over GRE data frame into a Point-to-Point Protocol (PPP) over Ethernet (PPPoE) data frame.

20. The WLAN APC claimed in claim 19 wherein the WLAN APC sends the PPPoE data frame to a WLAN client of a WLAN network.

21. The WLAN APC claimed in claim 19 wherein the WLAN APC receives the PPP over GRE data frame from a Packet Data Service Node (PDSN) of a CDMA2000 network.

22. The WLAN APC claimed in claim 19, wherein the WLAN APC converts a GRE header of the PPP over GRE data frame into an Ethernet header of the PPPoE data frame.

23. The WLAN APC claimed in claim 19, wherein the PPPoE data frame is a signaling data frame.

24. The WLAN APC claimed in claim 19, wherein the PPPoE data frame is a traffic data frame.
